(19) United States
(12) Patent Application Publication
(10) Pub. No.: US 2004/0028511 A1
(43) Pub. Date: Feb. 12, 2004

(54) Load transporter

(76) Inventor: Louis Richard Eaton, Ajax (CA)

Correspondence Address: BIRCH STEWART KOLASCH & BIRCH, PO BOX 747, FALLS CHURCH, VA, 22040-0747, US

(21) Appl. No.: 10/613,003

(22) Filed: Jul. 7, 2003

(30) Foreign Application Priority Data
Jul. 5, 2002 (CA) 2,392,572

(51) Int. Cl. B60P 9/00

(52) U.S. Cl. 414/462; 224/310

(57) ABSTRACT

A carrier elevates a boat from water where it is floating to above an open box and roof of a pickup truck where it can be transported. The carrier also elevates a light vehicle that travels on land from the ground to above a truck for transport. The carrier has a frame which is mounted on the truck, a carriage adapted to carry the boat or light vehicle and a bed having a track on which the carriage slides. The bed is pivotal from a carrying position to a loading/unloading position. In the carrying position, the bed is above the truck and the track is in a generally horizontal position. In the loading/unloading position, the track is tilted downwardly toward the rear of the truck such that the carriage may slide downwardly on the track toward the rear of the truck to allow a boat or light vehicle to be loaded onto the carriage or discharged from it should the boat or light vehicle already be on the carriage.

### BACKGROUND OF THE INVENTION

This invention relates to carriers and more particularly to a carrier for elevating a watercraft from water where it is floating to above an open box and roof of a pickup truck where it can be transported. The invention also relates to a carrier for elevating a vehicle that travels on land from the ground to above a truck for transport.

Pickup trucks are commonly used to transport relatively small and light watercraft such as outboard motorboats, sail-boats, canoes, personal watercraft such as sea-doos and to transport relatively small and light vehicles such as snowmobiles, all terrain vehicles (“A.T.V.”) and riding lawn mowers. Watercraft is usually loaded onto the truck by hand while vehicles are usually loaded onto the pickups by driving them up a ramp and onto the open bed of the pickup.

Usually many person are required to load a watercraft by hand. Very often there are not enough persons available to do so and even when there are, the persons find the lifting difficult and fraught with danger. Loading of vehicles which travel on land can result in damage to the vehicles and injury to persons driving them. The reason is that the upper edge of the ramps must rest solidly on the rear bumper of the pickup while the vehicle is being driven up the ramp. If the upper edge overhangs the bumper somewhat, the ramp will become unstable when the weight of the front wheels of the vehicle is on the overhang. At this point, the ramp will rock and become unstable and the driver may lose control of the vehicle.

On the other hand, if the upper edge of the ramp overhangs the bumper insufficiently, vibration of the vehicle on the ramp may cause the upper edge to fall off the bumper with resulting damage to the vehicle and injury to the driver.

I have invented a carrier that will elevate a carriage from the water or ground to above the open box and roof of a pickup truck. A watercraft can be floated to an end of the carriage and raised into the carriage by a hoist. A vehicle which travels on land such as a snowmobile, an A.T.V. and a riding mower can be driven to the end of the carriage and raised into it by the hoist. The hoist will then safely raise the watercraft or vehicle until it is above the open box and roof of the pickup. The watercraft and vehicle are then in position to be transported on the pickup. Reversing the action of the hoist allows the watercraft and vehicle to be unloaded from the pickup.

### SUMMARY OF THE INVENTION

Briefly the carrier of my invention selectively raises a watercraft or vehicle that travels on land to an elevated position above a truck and lowers the watercraft or vehicle to a lower position in which the watercraft or vehicle may be launched into water or set on land. The carrier includes a frame having means for attachment to the truck and a carriage adapted to carry the watercraft or vehicle. A bed has a track on which the carriage slides and is pivotally connected to the frame. The bed is pivotal from a watercraft- or vehicle- carrying position in which the bed is disposed above the truck and the track is in a generally horizontal position to a watercraft- or vehicle- launching position in which the track is tilted downwardly toward the rear of the truck such that the carriage may slide downwardly on the track toward the rear of the truck

### DESCRIPTION OF THE DRAWINGS

The hoist of the invention is described with reference to the accompanying drawings in which:

FIG. 1 is a perspective view of the carrier;

FIGS. 2 and 3 are elevations of the carrier as it is being unloaded;

FIG. 4 is an elevation of the carrier in position for transportation;

FIG. 5 is an end view, in enlarged scale, of the rear of the carrier;

FIG. 6 is an enlarged perspective view of a hitching post;

FIG. 7 is a perspective view of the carrier in conjunction within a truck and an outboard motorboat; and

FIG. 8 is a perspective view of the carrier, truck and motorboat as the motorboat is being unloaded onto water.

Like reference characters refer to like parts through-out the description of the drawings.

### DESCRIPTION OF PREFERRED EMBODIMENTS

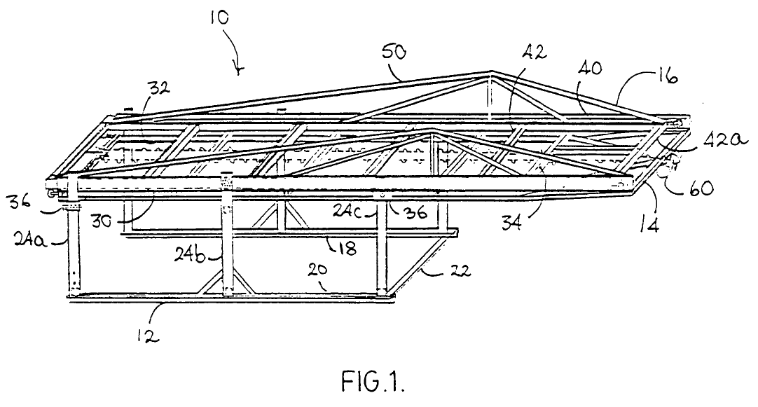

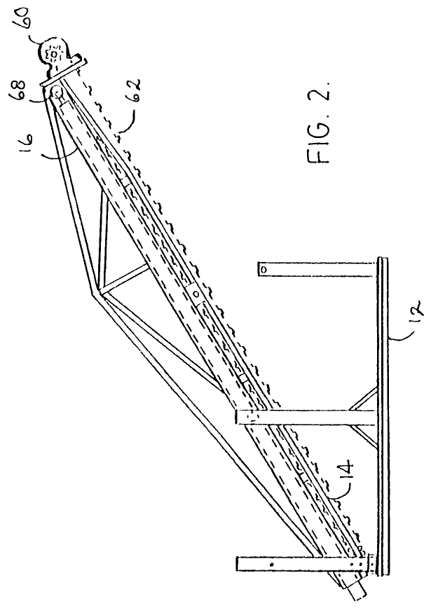

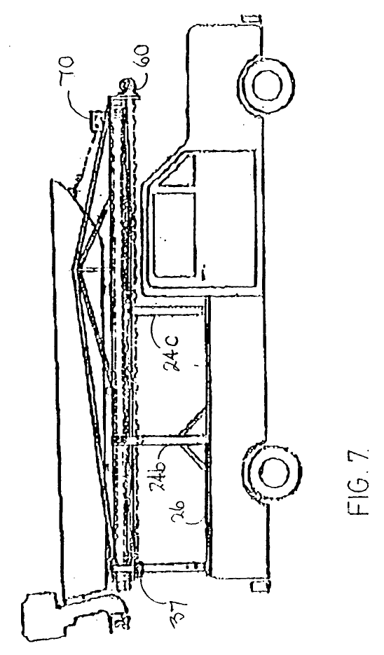

With reference to FIGS. 1 and 2, the carrier of the invention, generally 10, is made up of a frame 12, a bed 14 and a carriage 16. The frame is composed of a U-shaped base made up of a pair of parallel stringers 18, 20 and a cross-member 22 which joins the two stringers. Three posts 24a,b,c extend upwardly from each stringer. As illustrated in FIG. 7, the stringers are seated upon the side walls 26 of the open box of a truck and the cross-member is seated on the rear wall of the open box.

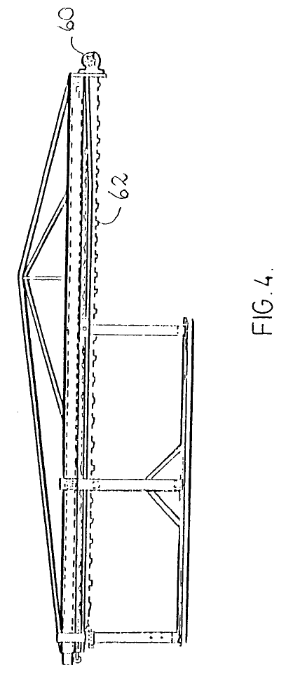

With reference to FIGS. 1 and 5, the bed is composed of a pair of channels 30, 32 and a number of cross-bars 34 which are connected to the lower wall of the channels and which hold the channels in a spaced parallel relationship. The channels are supported in stirrups 36 at the top of posts 24c on both sides of the frame and are pivotally connected to posts 24b

With reference to FIG. 5, the rear ends of the carriage is supported by an elongated horizontal rod 37 having sleeves 38a,b at opposite ends within which posts 24a are slidingly received. The posts are provided with a number of openings 39 which, when in registry with the openings in the sleeves, receive conventional locking pills (not illustrated) for securing the sleeves and bar at preselected levels.

As illustrated in FIGS. 1 and 3, the carriage has a pair of parallel side rails 40 and cross-bars 42 which extend between the side rails and maintain them parallel and spaced apart from one another. As illustrated in FIG. 5, the rails are received in the space between the upper and lower flanges of the channels and are free to slide within the channels.

An array of rods 50 extend upwardly from the connecting bars adjacent to each rail 40. The rods serve as side walls and prevent a watercraft or vehicle from rolling over sideways and falling from the carriage.

A hoist 60 composed of a motor, speed reducer and drive sprocket is mounted to cross-bar 34 at the forward end of the bed. An elongated conveyance-drawing means such as a chain 62 is trained about the drive sprocket. The chain extends beneath the bed and around a sheave 66 at the rear end of the bed. The chain extends from the sheave back to the drive sprocket to complete the loop. The cross-bar 42a at the forward end of the carriage is connected to the chain so when the chain moves the carriage moves relative to the bed.

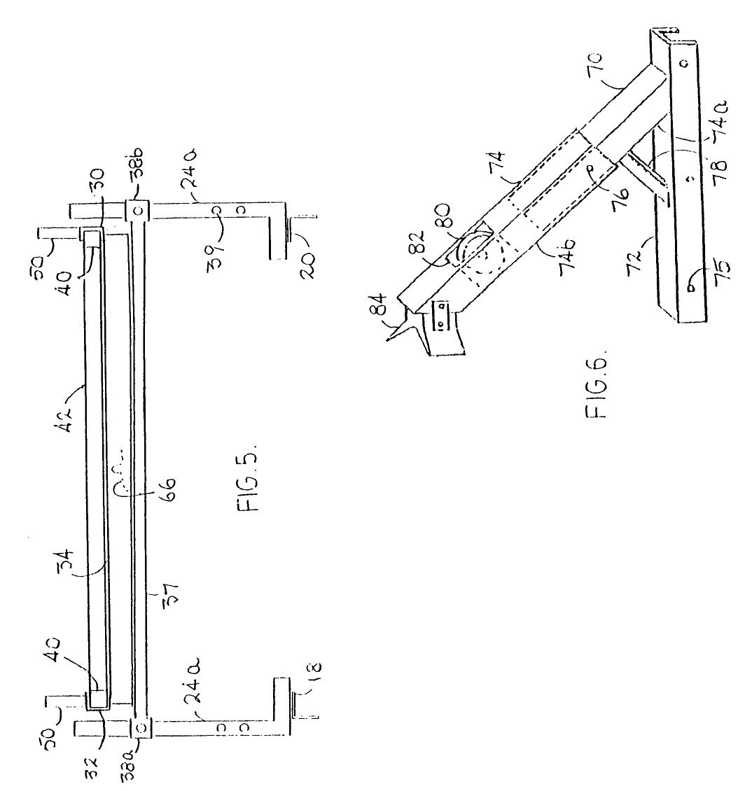

With reference to FIG. 6, a hitching post 70 is composed of a base 72 and a backwardly slanted and upwardly extending extendible arm 74. Both the base and extendible arm are composed of channels. Openings 75 are formed in the base for receipt of bolts so that the base can be attached to the carriage.

The extendible arm is composed of lower and upper sections 74a,b which slide relative to each other so that the effective length of the extendible arm can be adjusted. There are openings 76 in the sections (one illustrated) for receipt of a locking pin to secure the sections together to prevent them from sliding relative to each other once they are in the desired position. A strut 78 fixes the lower section in a stationary position relative to the base.

A sheave 80 is mounted for rotation to the upper section of the extendible arm and an opening 82 is formed in the section adjacent to the sheave for receipt of a rope (not illustrated) which extends from one side of the extendible arm to the other and which runs over the sheave.

At the top of the extendible arm is a notched stop member 84 against which the bow of a boat abuts.

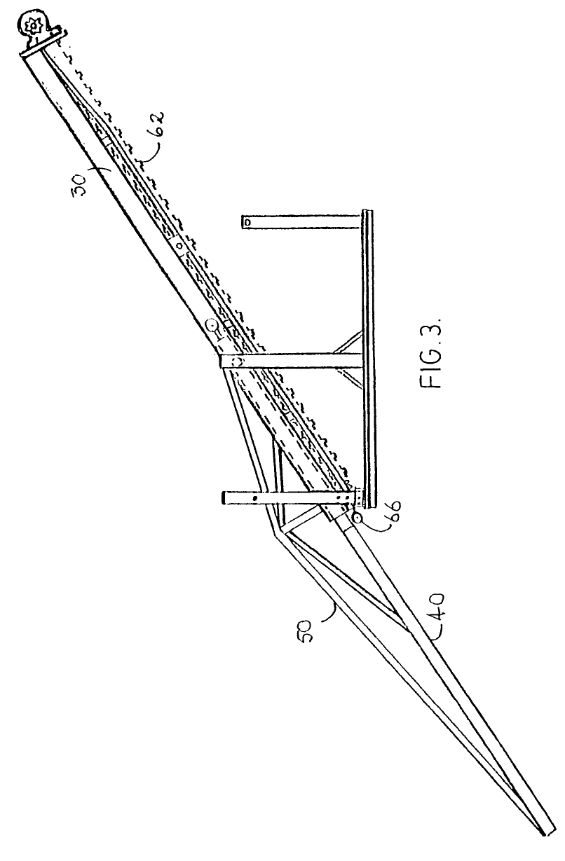

The operation of the carrier is as follows with reference first to FIG. 7, a watercraft is within the carriage above the roof of the truck. To ensure that the craft is securely attached to the carrier, straps or rope (not illustrated) are wrapped around the craft and are attached or tied to the carriage. Rollers may be provided on the carriage for facilitating the loading and unloading of the craft. The bow of the craft is connected to hitching post 70. Locking pins (not illustrated) pass through openings in the stirrups at the top of post 24c and into conforming openings in the stringers of the bed in order to anchor the bed solidly to the frame. Locking pins also maintain rod 37 in an upper position in order to support the rear end of the bed. The carrier will then be in the position illustrated in FIG. 4.

To unload the watercraft from the carrier, the locking pins that interconnect the stirrups to the frame are removed as are the pins that maintain rod 37 in the upper position so that the bed is only connected to the frame at two points, namely the pivotal connections at the tops of posts 24b. The rear end of the bed is free to drop until it contacts the rod in its lower position. Should the centre of gravity of the craft be rear of the pivotal connection, the bed will tip backward as illustrated in FIG. 2. Hoist 60 is activated in order to cause the carriage to slide backward.

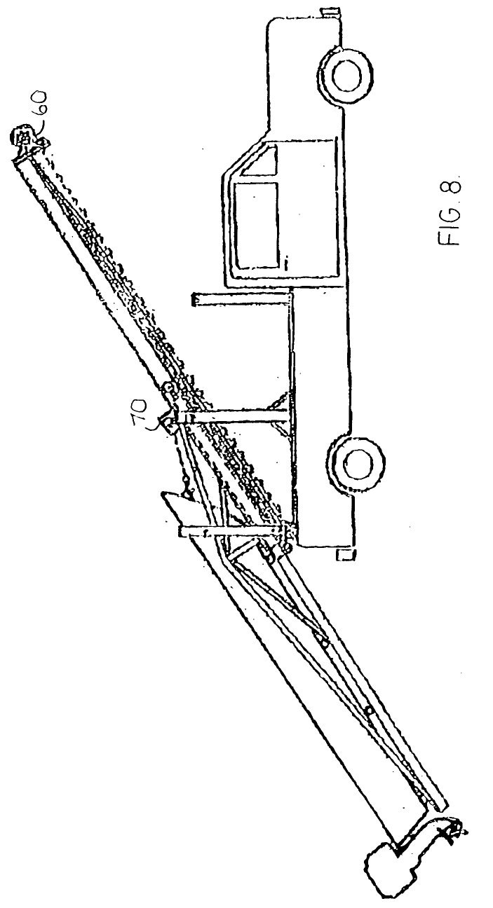

If the centre of gravity of the watercraft is forward of the pivotal connection, the forward end of the craft on the carriage is pushed toward the rear. As the craft moves backward on the carriage, its centre of gravity will pass over the pivotal connection then begin to separate horizontally from it. As it does, the bed and carriage will tilt toward the rear as illustrated in FIG. 3. Further backward movement will cause the carriage to approach the ground or water, as illustrated in FIG. 8.

The straps which attached the watercraft to the carriage are then removed and hoist 60 continues to extend the carriage outward to allow the craft to float in the water. The craft is then untied from hitching post 70.

It will be understood of course that modifications can be made in the embodiments of the carrier illustrated and described herein without departing from the scope and purview of the invention.

I claim:

1. A carrier for selectively raising a conveyance to an elevated position above a motor vehicle and for lowering the conveyance to a position in which the conveyance may be launched into water or onto land, said carrier including a frame having means for attachment to the motor vehicle; a carriage adapted to carry said conveyance; a bed having a track on which said carriage slides and being pivotally connected to said frame, said bed being pivotal from a conveyance-carrying position in which said bed is disposed above the motor vehicle and said track is in a generally horizontal position to a conveyance-loading/unloading position in which said track is tilted downwardly toward the rear of the motor vehicle such that said carriage may slide downwardly on said track toward the rear of the motor vehicle and unloaded therefrom or may slide upwardly therefrom after being loaded onto said track.

2. The carrier as claimed in claim 1 wherein said frame has a pair of stringers and first, second and third posts extending upwardly from each said stringer, the first post on each said stringer being closest to the rear end of the motor vehicle of the three posts on said stringer while the third post on each said stringer is closest to the front of the vehicle of the three posts on said stringer, said bed being pivotally connected to the second post on each said stringer.

3. The carrier as claimed in claim 1 further including a stirrup attached to said third post and supporting said bed when said bed is in said conveyance-carrying position.

4. The carrier as claimed in claims 2 further including a horizontal rod slidingly connect to the first post on each said stringer, said rod adapted to support said bed when said bed is in both said conveyance-carrying and said loading/unloading positions.

5. The carrier as claimed in claim further including a hoist and an elongated conveyance-drawing means, said hoist being attached to said bed and said drawing means being activated by said hoist, said carriage being connected to said drawing means and caused to slide thereby.

6. The carrier as claimed in claim 1 further including a hitching post which is connected to said carriage and to which a rope connected to said conveyance is adapted to be attached, said hitching post having an upstanding extendible arm composed of lower and upper sections which slide relative to each other so that the effective length of the extendible arm can be adjusted.

7. The carrier as claimed in claim 6 wherein said post has a sheave mounted for rotation thereto to facilitate the attachment of a rope thereto, said post further having a notched stop member against which the bow of a boat is adapted to abut.

8. The carrier as claimed in claim 1 wherein said conveyance travels over water.

9. The carrier as claimed in claim 1 wherein said conveyance travels over land.
